(19) United States
(12) Patent Application Publication
(10) Pub. No.: US 2006/0117283 A1
(43) Pub. Date: Jun. 1, 2006

(54) Integrated circuit verification method, verification apparatus, and verification program

(75) Inventors: Tetsuya Katou, Kanagawa (JP); Makoto Nonaka, Kanagawa (JP); Hideyuki Okabe, Kanagawa (JP); Kazuhisa Shimazu, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/283,693

(22) Filed: Nov. 22, 2005

(30) Foreign Application Priority Data
Dec. 1, 2004 (JP) 2004-348984

(51) Int. Cl. G06F 17/50; G06F 9/45

(52) U.S. Cl. 716/5; 716/10

(57) ABSTRACT

A verification method of an integrated circuit including an input/output buffer placed in a periphery of a semiconductor device and an internal circuit. The verification method stores physical information on routing of the input/output buffer into a library of the input/output buffer and verifies a placement of the input/output buffer based on the physical information.

### BACKGROUND OF THE INVENTION

1. Field of the invention

The present invention relates to an integrated circuit and, particularly, to a verification method, verification apparatus, and verification program of the integrated circuit.

2. Description of the Related Art

An integrated circuit is designed by using a plurality of libraries corresponding to functional cells. The designed circuit is verified by using placement data or the like in design phase.

FIG. 10 is a view that shows a conventional process of integrated circuit design and design verification. The integrated circuit design process includes floorplan that arranges functional blocks in a semiconductor device. The floorplan is performed based on user netlist, which is data that represents circuit connection. The process also includes determination of placement of input/output (I/O) buffers that are placed in the periphery of a chip or the like. The placement of the I/O buffers is determined based on the placement of an internal circuit that is determined by the floorplan (S101 in FIG. 10). Then, power routing for the internal circuit is designed (S102 in FIG. 10). After determining the power routing for the internal circuit, placement and routing of functional devices, signal lines and so on in the internal circuit are determined (S103 in FIG. 10).

After determining the power routing for the internal circuit and the placement and routing of the internal circuit, Layout Versus Schematic (LVS) netlist is output (S104 in FIG. 10). The LVS is a verification to check if placement corresponds to a circuit diagram in design based on the designed placement data of the internal circuit.

Then, netlist of power routing that includes placement of I/O buffers to connect the internal circuit with a power supply, an I/O pad and so on is created (S105 in FIG. 10).

After that, LVS netlist including power routing is created and LVS verification is performed to check if the designed placement corresponds to a circuit diagram (S106 in FIG. 10).

Such a design method is described in Japanese Unexamined Patent Application Publication No. 08-69484, and a technique of LVS verification is described in Japanese Unexamined Patent Application Publication No. 2002-343846, for example.

A recent integrated circuit with an internal circuit and an I/O buffer placed in its periphery has a large number of interfaces with other apparatus. It is therefore necessary to place I/O buffers that correspond to a variety of power supplies to be compatible with each interface. In some cases, routing that corresponds to a variety of power supplies are formed inside the I/O buffer and connected to an adjacent I/O buffer.

A technique for placement of a plurality of kinds of buffers is described in Japanese Unexamined Patent Application Publication No. 2001-44370, for example.

However, the present invention has recognized that a conventional system used for design and verification has a problem that data on an I/O buffer indicates only information about its input and output. It is therefore difficult to create LVS netlist that includes routing connection between adjacent I/O buffers and power routing in an I/O buffer after designing an internal circuit.

### SUMMARY OF THE INVENTION

According to an aspect of the present invention, there is provided a verification method of an integrated circuit including an input/output buffer placed in a periphery of a semiconductor device, and an internal circuit. The verification method stores physical information on routing of the input/output buffer into a library of the input/output buffer and verifies a placement of the input/output buffer based on the physical information.

According to another aspect of the present invention, there is provided a verification method of an integrated circuit including an input/output buffer placed in a periphery of a semiconductor device and an internal circuit. The verification method stores connection information on routing of the input/output buffer into a library of the input/output buffer, generates circuit connection information of the semiconductor device based on connection information of the input/output buffer and the internal circuit, and performs Placement Versus Schematic (LVS) verification by comparing placement data including the input/output buffer and the internal circuit with the circuit connection information.

According to yet another aspect of the present invention, there is provided an automatic placement/routing verification apparatus of an integrated circuit, which includes a placement generation section performing automatic placement/routing of an integrated circuit by using a cell library containing physical information on a placement of functional cells including an input/output buffer and connection information on logical connection of functional cells, and a user netlist of a circuit implemented by a combination of the functional cells. The placement generation section includes an input/output buffer placement verification section that inputs floorplan prior to the automatic placement/routing and performs adjacent placement check between input/output buffers placed adjacent to each other based on the floorplan and a type and position of power routing included in the input/output buffer.

Since the present invention stores physical information and connection information in a library of an input/output buffer and uses them for generating netlist in input/output buffer placement verification and LVS verification, it is possible to increase the accuracy in a verification process of an integrated circuit and simplify the process.

Further, it is possible to facilitate verification of connection between adjacent input/output buffers and placement verification after circuit placement.

### BRIEF DESCRIPTION OF THE DRAWINGS

The above and other objects, advantages and features of the present invention will be more apparent from the following description taken in conjunction with the accompanying drawings, in which:

FIG. 1A is a view schematically showing an I/O buffer;

FIG. 1B is a view showing placement of I/O buffers;

FIG. 2 is a view schematically showing a verification apparatus of an integrated circuit;

FIG. 3 is a view showing a verification method according to an embodiment of the invention;

FIG. 4 is a view showing a verification method according to an embodiment of the invention;

FIG. 5 is a view showing a placement example of I/O buffers when using different power supplies;

FIG. 6 is a view where the I/O buffers of FIG. 5 are connected to an internal circuit;

FIGS. 7A and 7B are views where different substrate potentials are applied to an I/O buffer and an internal circuit;

FIGS. 8A to 8C are views showing a case where different substrate potentials are used also in an internal circuit;

FIG. 9 is a view showing shrinking of data of an I/O buffer; and

FIG. 10 is a view showing a conventional verification method.

### PREFERRED EMBODIMENT OF THE INVENTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

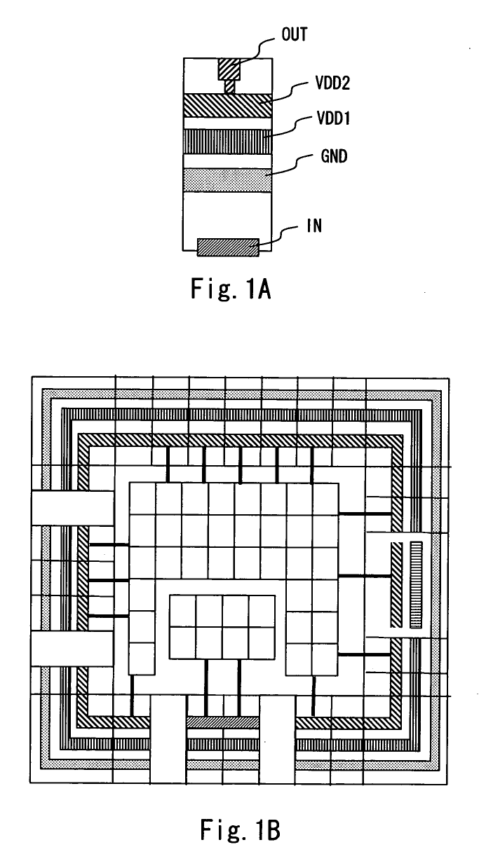

A verification apparatus that is used in a verification method of an integrated circuit according to an embodiment of the present invention has a library of an I/O buffer that associates physical information and connection information of the I/O buffer in a cell library. An example of the physical information of the I/O buffer that is stored in the library is described hereinafter with reference to FIG. 1A.

FIG. 1A shows an example of a basic configuration of one I/O buffer. A cell library of this embodiment includes a plurality of cells according to types of I/O buffers. In the example of an I/O buffer shown in FIG. 1A, a ground line GND is placed in the closest proximity to an input pad IN, and a first power line VDD1 is placed in the second-closest proximity thereto. A second power line VDD2 is placed in connection with a terminal OUT that supplies power to the internal circuit. The cell library of the verification apparatus used in this embodiment includes physical information such as routing positions of the ground line GND and the power lines VDD1 and VDD2, which are shown in FIG. 1A, and connection information of the power line, for example.

A cell library has physical information such as power routing line width and placement position for a plurality of I/O buffers. Together with the physical information, it also has connection information on a power supply that is connected to the lines in the I/O buffer, a power supply that is connected to the internal and so on.

The format of the physical information is arbitrary. For example, it is feasible to store one power routing by regarding it as a polygon that is formed inside a basic cell. The physical information and the connection information may be created by extracting necessary data from design data of the I/O buffer, for example.

In actual placement of I/O buffers, a plurality of different types of I/O buffers are placed in the peripheral part for each section with a different power supply, for example (see Sig. 1B). Thus, the cell library stores physical information and connection information of a plurality of I/O buffers.

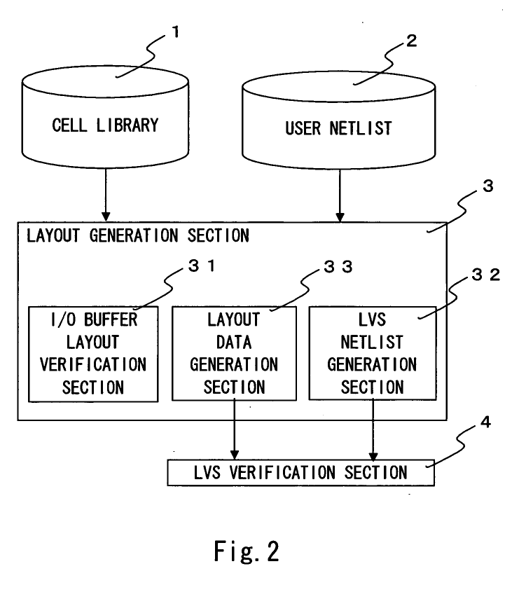

A verification apparatus of an integrated circuit according to an embodiment of the present invention designs a placement based on the cell library and user netlist and then verifies the placement against a circuit diagram. FIG. 2 shows a schematic configuration of the verification apparatus of this embodiment. As shown in FIG. 2, the verification apparatus of this embodiment includes a cell library 1, a user netlist 2, a placement generation section 3, and an LVS verification section 4. The cell library 1 includes a library about another functional cell in addition to the library about an I/O buffer. The user netlist 2 is a list that indicates connection information of a circuit to be designed, which corresponds to circuit diagram data of a circuit to be designed. The placement generation section 3 performs placement design based on the cell library 1 and the user netlist. It further performs placement verification of I/O buffers, output of designed placement data and LVS netlist for LVS verification, and so on. The LVS verification section 4 compares placement data with LVS netlist and performs LVS verification.

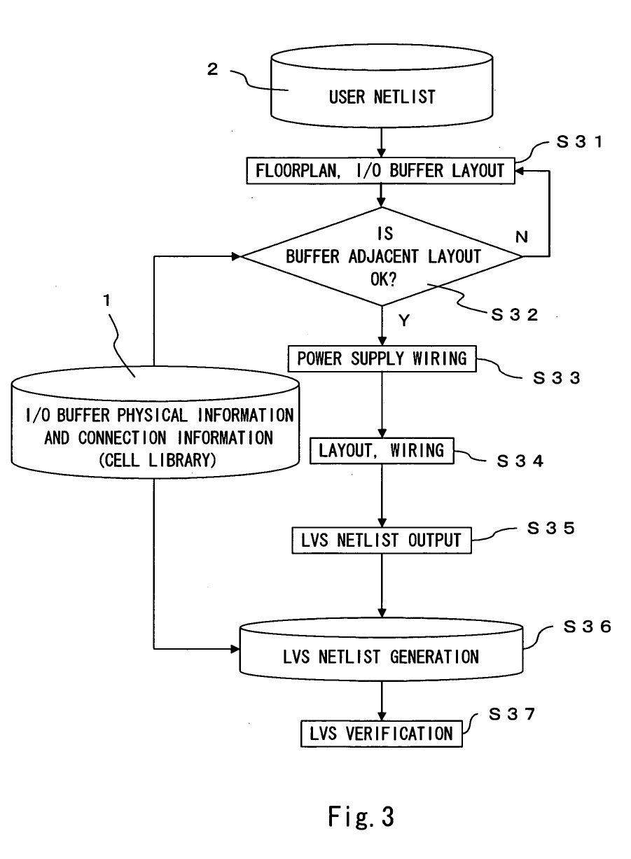

A verification method of an integrated circuit that uses the above verification apparatus is described hereinafter with reference to FIG. 3. The verification method of this embodiment firstly inputs user netlist, which is circuit connection information. Based on the netlist, floorplan is performed to placement functional blocks in a semiconductor device. At the same time as the floorplan, placement of I/O buffers, which are arranged in the periphery of a chip or the like, is performed (S31 in FIG. 3).

The cell library 1 shown in FIG. 2 includes the physical information and connection information of power routing for each I/O buffer. The placement generation section 3 has an I/O buffer placement verification section 31. In the placement of I/O buffers, the I/O buffer placement verification section 31 verifies connection between adjacent I/O buffers by using the physical information of the I/O buffer that is stored in the cell library 1 (S32 in FIG. 3).

The verification of adjacent placement compares coordinate information and power information on power routing of adjacent buffers in the placement of I/O buffers. For example, if an I/O buffer that has a VDD1 line in the position of the GND line of the I/O buffer in FIG. 1A is placed adjacent to the I/O buffer in FIG. 1A, different power supplies are short-circuited in the adjacent I/O buffers. Therefore, the verification of adjacent buffers verifies if the placement of I/O buffers is appropriate by using the physical information and connection information of power routing of the I/O buffers. If it detects short-circuit of different power supplies between adjacent I/O buffers, the process returns to Step S31 to replacement the I/O buffers. If, on the other hand, the placement verification finds no error in the adjacent buffers and the placement of the I/O buffers ends, the process proceeds to the next step.

After the verification of I/O buffer adjacent placement, the placement generation section 3 in FIG. 2 performs routing of power lines for the internal circuit (S33 in FIG. 3). After determining the power routing for the internal circuit, it determines placement and routing in the internal circuit (S34 in FIG. 3).

Based on the placement and routing results, timing verification is performed to check if the placement circuit satisfies a predetermined timing. If it does not satisfy a predetermined timing, the process performs insertion of a repeater buffer, elimination of a buffer, resizing of a buffer and so on before eventually determines placement data.

Then, the placement generation section 3 outputs a netlist that is extracted from the placement data as netlist for LVS (S35 in FIG. 3). If circuit adjustments such as repeater buffer insertion and buffer elimination have been performed as a result of the timing verification as described above, the process verifies if the adjusted placement data retains a logic of an original circuit and if the LVS netlist is equivalent with the original netlist so as to assure that it is logically equivalent with the original circuit.

In this embodiment, the cell library 1 stores connection information of I/O buffers. Therefore, after the placement of I/O buffers is determined, it is possible to generate connection information (netlist) of power routing on the I/O buffer part (peripheral circuit part). Thus, in the verification method of this embodiment, the LVS netlist generation section 32 in the placement generation section 3 generates LVS netlist by adding netlist of power supply on the I/O buffers to the data of netlist used for chip design and supplies it to the LVS verification section 4 (S35 in FIG. 3).

Then, the placement generation section 3 generates connection information based on placement data (placement netlist) by using the designed power routing of the internal circuit (S36 in FIG. 3). After that, the LVS verification section 4 compares graphic data in actual placement with the LVS netlist that is generated by reflecting the connection information of the I/O buffers of the cell library, thereby performing LVS verification (S37 in FIG. 3).

Thus, in the verification method of the integrated circuit of this embodiment, the cell library 1 in the circuit design phase includes physical information and connection information of I/O buffers. Since this method prepares the cell library 1 that prestores physical information and connection information of I/O buffers, it allows verification of errors in the placement of adjacent buffers during the placement of I/O buffer, which enables to generate a netlist that includes an I/O buffer part during the LVS verification of the circuit. This eliminates man-hour that is required for I/O buffer placement and LVS verification.

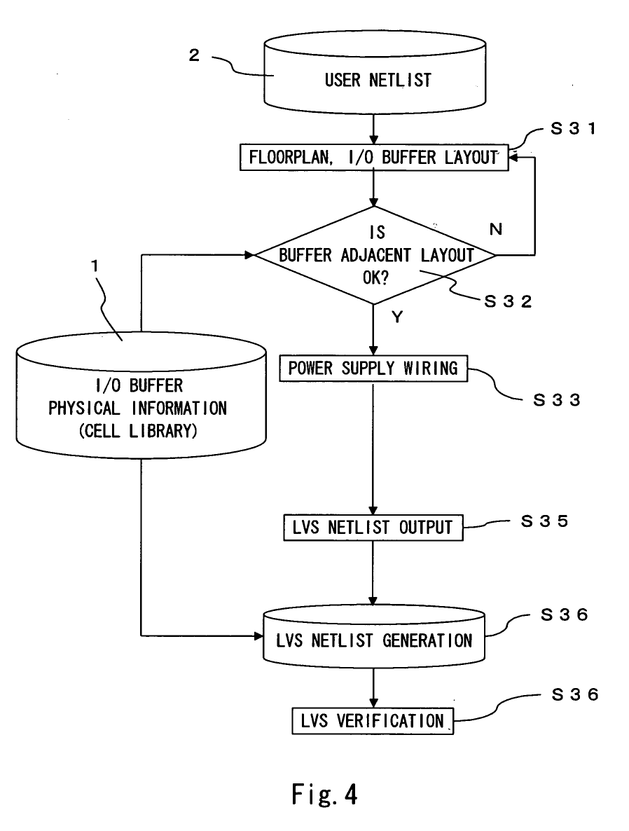

FIG. 4 shows an example of a verification flow that performs LVS verification on power routing based on a cell library of an I/O buffer and placement data of power routing of an internal circuit without performing the process of internal circuit placement and routing in FIG. 3. In other words, it shows the verification method where the process corresponding to S34 in FIG. 3 is eliminated.

Adjacent I/O buffers are generally connected by power routing. Thus, after determining power routing in the internal circuit, it is possible to generate LVS netlist only on power routing in combination with the I/O buffer part. Performing LVS verification on power routing in advance allows performing LVS verification on power routing including a power system of the internal circuit before forming routing of the internal circuit.

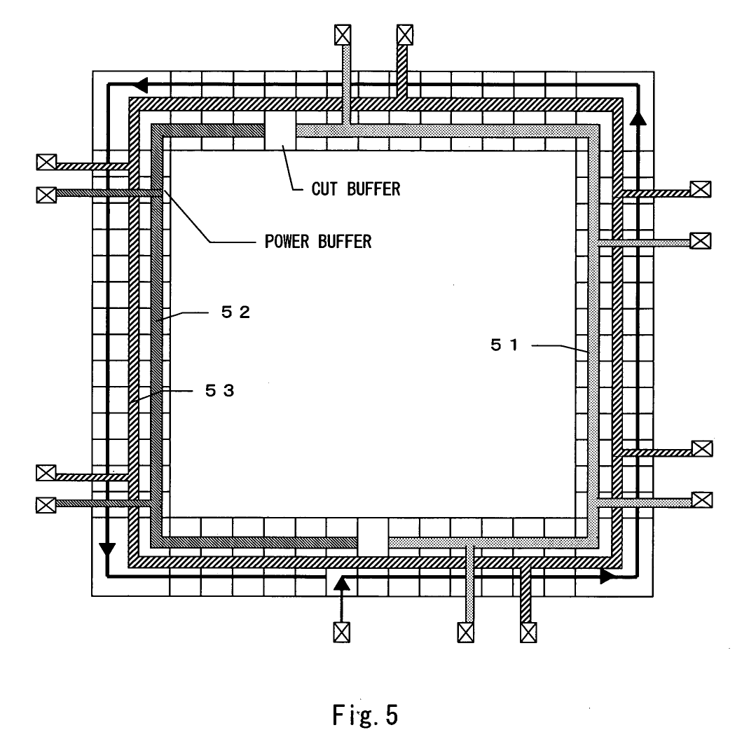

The case of generating a netlist for each power system is described hereinafter with a specific example. FIG. 5 shows a configuration example of an I/O buffer part that has a first power supply 51, a second power supply 52, and a third power supply 53. As shown in FIG. 5, the first power supply 51 supplies power to the right half of a semiconductor device in FIG. 5. The second power supply 52 supplies power to the left half of the semiconductor device in FIG. 5. The third power supply 53 supplies power so as to surround the chip periphery.

Since information about which power line should the I/O buffer part be connected to can be determined with design data of one chip even when the I/O buffer part uses a plurality of power routing lines, it is possible to generate an LVS netlist by using the connection information. The LVS verification using this LVS netlist can check if the I/O buffer part is connected to a wrong power system. Further, a cut buffer, which is an I/O buffer to cut a power line, is placed between different power routing. Therefore, the LVS can also check if separation between power supplies is made correctly.

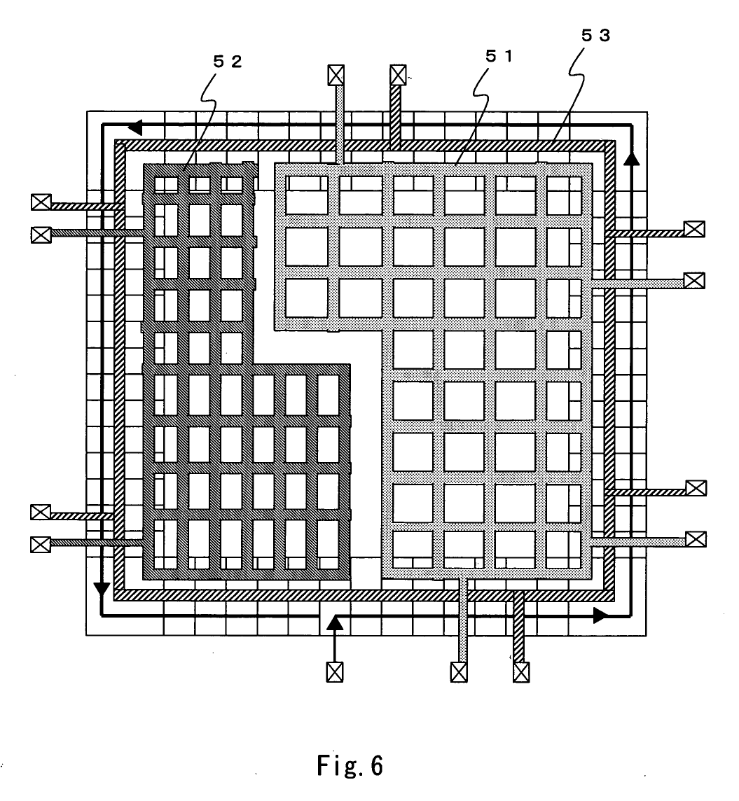

FIG. 6 is a view showing the state where a plurality of power supplies of I/O buffers shown in FIG. 5 are connected to the internal circuit. As shown in FIG. 6, even when the internal circuit uses a plurality of power systems, it is possible to check if connection with power supplies is made correctly. Specifically, it refers to a cell library of an I/O buffer, generates LVS netlist from design data of one chip, and couples this netlist with the netlist of the internal circuit, thereby performing LVS verification of the entire power routing.

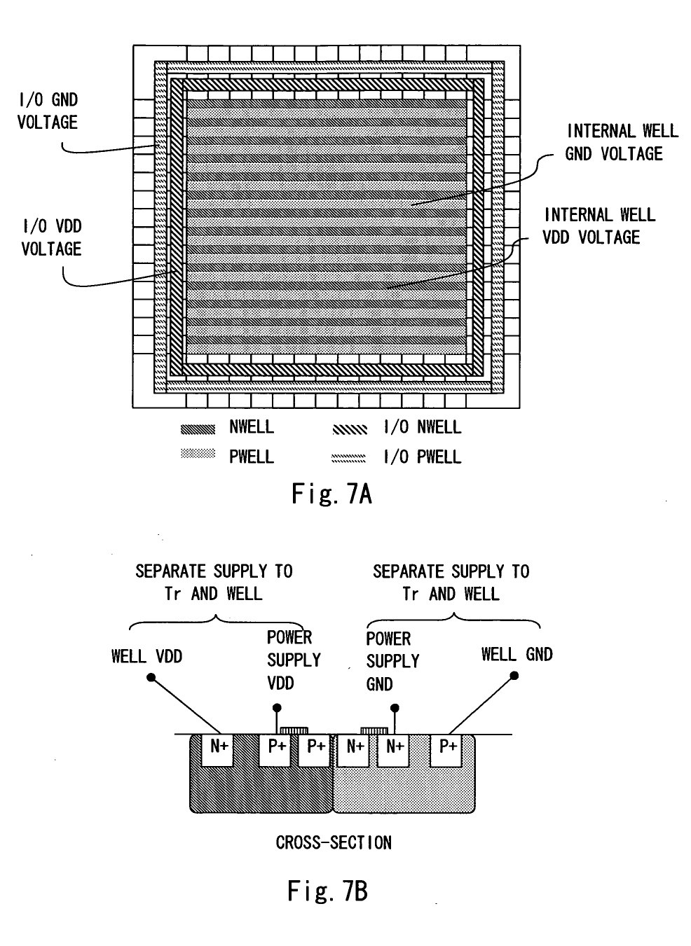

Further, the connection information stored in the cell library of the I/O buffer may also include connection information of well potential. FIGS. 7A and 7B show a case where a well need to be separated between a power supply of an I/O buffer part and an internal circuit. Power that is supplied to the substrate (well) is defined on power netlist for each power supply and LVS verification is performed thereon.

It is thus possible to define a power netlist for each power supply even when power supplied to the substrate of the internal circuit area and power supplied to the substrate of the I/O buffer are different. In this case, the cell library of the I/O buffer has connection information on well potential. It is feasible to generate a netlist that includes well connection by using the connection information. Generating an LVS netlist by using this netlist allows checking if separation is made correctly in LVS.

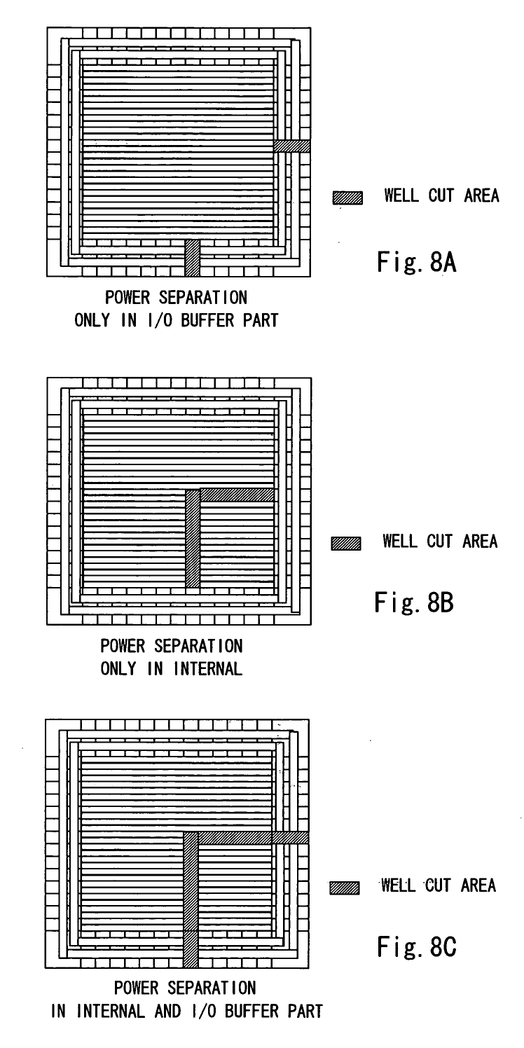

FIGS. 8A to 8C show a case where a well need to be separated in an I/O buffer part as well. FIG. 8A shows a case where a substrate (well) is separated in an I/O buffer part, FIG. 8B shows a case where a substrate (well) is separated in an internal circuit part, and power supply varies by substrate (well). FIG. 8C shows a case where a substrate is separated in an internal circuit part and an I/O buffer part, and power supply varies by substrate (well). Just like the case of FIGS. 7A and 7B, the connection information of I/O buffers is stored in the cell library of the I/O buffer. As shown in FIG. 8, when it is necessary to separate a well in the peripheral part, an LVS netlist is generated from the data of the cell library that includes well connection of the peripheral circuit as well. Then, LVS verification is performed to check if the well is separated correctly.

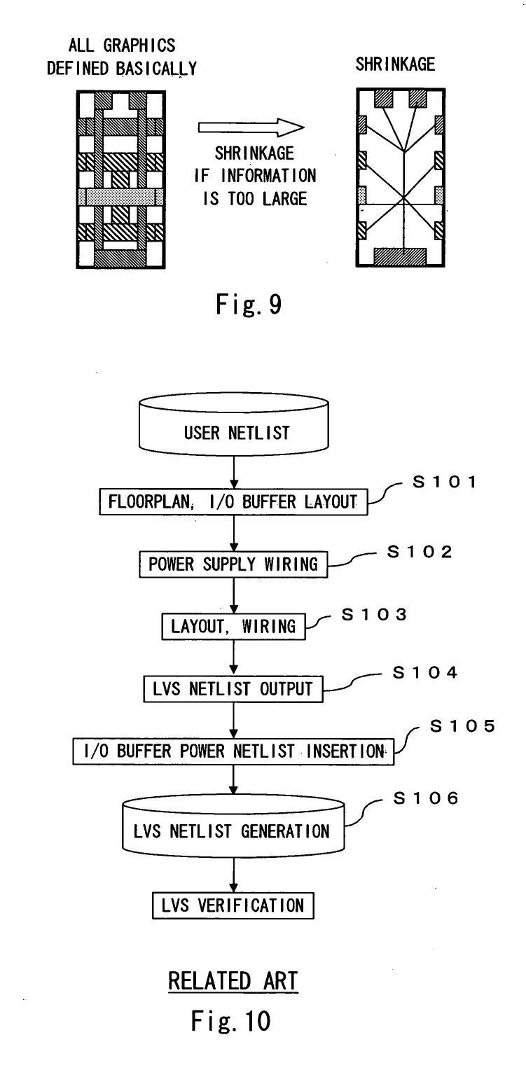

Though the above embodiment describes the case where the cell library of the I/O buffer has physical information that includes information on line width and so on, the format of coordinate information or the like may be varied arbitrarily as described earlier. FIG. 9 conceptually shows an example of a variation. The physical information of an actual I/O buffer can contain power routing line width and so on as shown in the left part of FIG. 9. However, verification of adjacent placement of I/O buffers or the like is feasible only with information about the position and voltage of power routing that is placed in its periphery. Thus, as shown in FIG. 9, it is feasible to limit the information to be stored in the cell library of the I/O buffer to position information, voltage information and so on in the peripheral part so as to reduce the amount of information stored.

Though an embodiment of the present invention is described in detail with a specific example in the foregoing, the present invention is not restricted to the above-mentioned embodiment but may be varied in many ways. In sum, the present invention increases the efficiency of I/O buffer placement and the facility of LVS verification by using a cell library that stores physical information and connection information on an I/O buffer that is used in floorplan of an integrated circuit. Though the verification apparatus in the above embodiment has the LVS netlist generation section, the I/O buffer placement verification section and so on inside the placement generation section, the present invention is not restricted thereto and these components may be implemented on software.

What is claimed is:

1. A verification method of an integrated circuit including an input/output buffer placed in a periphery of a semiconductor device, and an internal circuit, the verification method comprising:
storing physical information on routing of the input/output buffer into a library of the input/output buffer; and
verifying a placement of the input/output buffer based on the physical information.

2. The verification method of the integrated circuit according to claim 1, wherein the physical information contains information on a position of the routing included in the input/output buffer.

3. The verification method of the integrated circuit according to claim 2, wherein connection information of the routing included in the input/output buffer is stored in addition to the physical information.

4. The verification method of the integrated circuit according to claim 3, wherein during the placement of the input/output buffer, adjacent placement verification is performed by using connection information and routing position information of each of input/output buffers placed adjacent to each other.

5. A verification apparatus of an integrated circuit, wherein the apparatus implements a verification method according to claim 1.

6. A verification apparatus of an integrated circuit, wherein the apparatus implements a verification method according to claim 2.

7. A verification apparatus of an integrated circuit, wherein the apparatus implements a verification method according to claim 3.

8. A verification apparatus of an integrated circuit, wherein the apparatus implements a verification method according to claim 4.

9. A verification method of an integrated circuit including an input/output buffer placed in a periphery of a semiconductor device and an internal circuit, the verification method comprising:
storing connection information on routing of the input/output buffer into a library of the input/output buffer;
generating circuit connection information of the semiconductor device based on connection information of the input/output buffer and connection information of the internal circuit; and
performing Placement Versus Schematic (LVS) verification by comparing placement data including the input/output buffer and the internal circuit with the circuit connection information.

10. The verification method of the integrated circuit according to claim 9, wherein the circuit connection information is circuit connection information of power routing.

11. A verification apparatus of an integrated circuit, wherein the apparatus implements a verification method according to claim 9.

12. An automatic placement/routing verification apparatus of an integrated circuit, comprising:
a placement generation section performing automatic placement/routing of an integrated circuit by using a cell library containing physical information on a placement of a functional cell including an input/output buffer and connection information on logical connection of a functional cell, and a user netlist of a circuit implemented by a combination of the functional cells,
wherein the placement generation section comprises an input/output buffer placement verification section inputting floorplan prior to the automatic placement/routing and performing adjacent placement check between input/output buffers placed adjacent to each other based on the floorplan and a type and position of power routing included in the input/output buffer.

13. The automatic placement/routing verification apparatus according to claim 12, further comprising:
a Placement Versus Schematic (LVS) verification section,
wherein the placement generation section includes a placement data generation section generating placement data of the integrated circuit based on physical information of the cell library and the user netlist, and a LVS netlist generation section generating a netlist of a circuit including an input/output buffer based on the connection information contained in the cell library and the user netlist, and
the LVS verification section verifies if graphic data of a placement generated by the placement data generation section and a netlist including an input/output buffer generated by the LVS netlist generation section correspond to each other.
